(19) United States
(12) Patent Application Publication
(10) Pub. No.: US 2018/0129663 A1
(43) Pub. Date: May 10, 2018

(54) SYSTEMS AND METHODS FOR EFFICIENT DATA SAMPLING AND ANALYSIS

(71) Applicant: Facebook, Inc., Menlo Park, CA (US)

(72) Inventors: Ivan Vladimirov Ivanov, London (GB); Kia Dalili, New York, NY (US); Victor-Cristian Ionescu, London (GB); Abhishek Doshi, London (GB); Guangqiang Dong, Union City, CA (US)

(21) Appl. No.: 15/346,575

(22) Filed: Nov. 8, 2016

(51) Int. Cl. G06F 17/30

(52) U.S. Cl. CPC G06F 17/3053; G06F 17/30867

(57) ABSTRACT

Systems, methods, and non-transitory computer-readable media can select a first sample set comprising one or more data elements from a dataset based on a first priority score ranking at a first time for a first analysis. A second sample set comprising one or more data elements from the dataset is selected based on a second priority score ranking at a second time for a second analysis. An evaluation subset of one or more data elements from the second sample set is determined based on a comparison of the first sample set and the second sample set. The data elements in the second sample set that are not included in the evaluation subset are not analyzed ni the second analysis.

### FIELD OF THE INVENTION

The present technology relates to the field of data sampling. More particularly, the present technology relates to systems and methods for efficient data sampling and analysis.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Computing devices today are capable of creating and storing large amounts of data. With the decreasing cost of storage, and improvements in computing technology, more data can be gathered and stored than ever before. Given the massive amounts of data being collected and stored, it may be infeasible for anyone to review all data available for a particular purpose. In such scenarios, data sampling can be a useful way to make conclusions about a dataset based on a subset, or a sample set, that is generally representative of the dataset as a whole.

### SUMMARY

Various embodiments of the present disclosure can include systems, methods, and non-transitory computer readable media configured to select a first sample set comprising one or more data elements from a dataset based on a first priority score ranking at a first time for a first analysis. A second sample set comprising one or more data elements from the dataset is selected based on a second priority score ranking at a second time for a second analysis. An evaluation subset of one or more data elements from the second sample set is determined based on a comparison of the first sample set and the second sample set. The data elements in the second sample set that are not included in the evaluation subset are not analyzed ni the second analysis.

In an embodiment, each data element of the dataset is associated with a weight.

In an embodiment, each data element of the dataset is associated with a random number.

In an embodiment, each random number is determined based on a unique ID associated with each data element.

In an embodiment, each data element of the dataset is associated with a priority score determined based on the weight and the random number.

In an embodiment, the first sample set comprises the top k data elements in the dataset based on the first priority score ranking at the first time, k being a predetermined number, and the second sample set comprises the top k data elements in the dataset based on the second priority score ranking at the second time

In an embodiment, the dataset comprises a places of interest database, and each data element in the places of interest database is associated with a place of interest page on a social networking system

In an embodiment, the weight associated with each place of interest page in the places of interest database is determined based on social networking system interaction information for each place of interest page.

In an embodiment, the first analysis and the second analysis comprises analyzing accuracy of information contained in place of interest pages.

In an embodiment, the determining an evaluation subset comprises including in the evaluation subset data elements in at least one of the following categories: data elements in the second sample set that were not in the first sample set; data elements in the second sample set that were in the first sample set and have been modified; data elements in the second sample set that were in the first sample set, have been modified, and satisfy a change threshold determination; or data elements in the second sample set that were in the first sample set, and for which a result of the first analysis indicated the need for additional analysis.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an efficient sampling module, according to an embodiment of the present disclosure.

FIG. 2 illustrates an example sample set selection module, according to various embodiments of the present disclosure.

FIG. 3 illustrates an example evaluation subset determination module, according to various embodiments of the present disclosure.

FIG. 4 illustrates an example scenario associated with selecting an evaluation subset, according to an embodiment of the present disclosure.

FIG. 5 illustrates an example method associated with efficient sampling, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Efficient Data Sampling and Analysis

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Computing devices today are capable of creating and storing large amounts of data. With the decreasing cost of storage, and improvements in computing technology, more data can be gathered and stored than ever before. Given the massive amounts of data being collected and stored, it may be impractical or infeasible for anyone to review all data available for a particular purpose. In such scenarios, data sampling can be a useful way to make conclusions about a dataset based on a subset, or a sample set, that is generally representative of the dataset as a whole.

A dataset can include one or more data elements. As the information in the dataset changes, new data elements may be added to the dataset, certain data elements may be removed from the dataset, and certain data elements in the dataset may be changed or updated. Periodic evaluation and/or analysis of the information contained in a dataset may be desirable to, for example, observe changes in the dataset and/or draw conclusions based on or about the information in the dataset. However, evaluation and analysis of a dataset may require review of the information contained in the dataset. As discussed above, it may be the case that a dataset is extremely large. As such, it may be impractical to review all information in the dataset. In such scenarios, a representative sample set can be selected from the dataset, and the representative sample set can be reviewed. However, in certain scenarios, for example, when a dataset is so large that even a representative sample set is prohibitively large, or when a dataset must be analyzed frequently, even computerized review of representative sample sets in accordance with conventional techniques may be undesirably expensive and resource-consuming.

An improved approach rooted in computer technology overcomes the foregoing and other disadvantages associated with conventional approaches specifically arising in the realm of computer technology. In general, given a dataset that may be changing over time, a first sample set of one or more data elements can be selected from the dataset at a first time for a first analysis. Once a period of time has passed, a second sample set of one or more data elements can be selected from the dataset at a second time for a second analysis. In order to make analysis of the second sample set more efficient, the second sample set can be selected in such a way that the second sample set has overlap with the first sample set. The overlap between the second sample set and the first sample set creates the possibility that at least some of the data elements in the second sample set that were also in the first sample set do not need to be analyzed in the second analysis. A sampling procedure can be utilized that increases the likelihood of overlap between sample sets. For example, in certain embodiments, each data element in a dataset can be associated with a weight and a random number. A priority score can be determined for each data element in the dataset based on the weight and the random number. The dataset can be ranked based on priority scores, and a sample set can be selected based on the ranking, e.g., by selecting the top k data elements based on the ranking. By selecting the top k data elements based on a priority score ranking, the probability of overlapping sample set selections is increased, thereby increasing the likelihood that one or more of the overlapping data elements do not have to be analyzed in subsequent analyses. More details regarding the present technology are described herein.

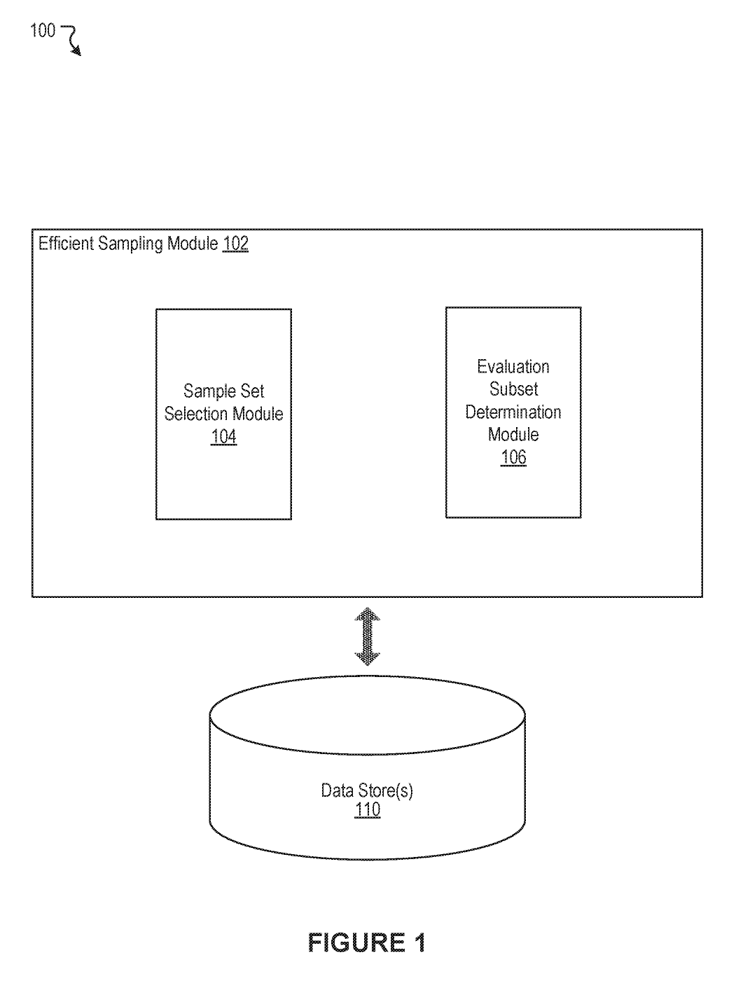

FIG. 1 illustrates an example system 100 including an example efficient sampling module 102, according to an embodiment of the present disclosure. The efficient sampling module 102 can be configured to select sample sets from a dataset that increase the likelihood of overlapping data elements in the sample sets, thereby increasing the likelihood of creating efficiencies in analyzing the sample sets. For example, a first sample set comprising one or more data elements can be selected from a dataset at a first time for a first analysis. In the first analysis, each of the one or more data elements in the first sample set can be analyzed so as to, for example, draw conclusions about the dataset at the first time. After a passage of time, a second sample set comprising one or more data elements can be selected from the dataset at a second time for a second analysis. In order to create some potential efficiencies in the second analysis, the second sample set can be selected in such a way that there are data elements in the second sample set that are also contained in the first sample set, i.e., “overlap with” the first sample set. Since any data elements that were in the first sample set were already reviewed in the first analysis, those overlapping data elements may not need to be analyzed again in the second analysis. This would, of course, decrease the amount of work that needs to be undertaken in the second analysis. Similarly, if a third sampling and analysis is undertaken at a later third time, any data elements in the third sample set that overlap with the first sample set and/or the second sample set may not need to be analyzed in the third analysis.

The efficient sampling module 102 can be configured to select sample sets in such a way as to increase the likelihood of overlap in sample sets, while still maintaining the integrity and representative nature of the sample set. Sampling methodologies that achieve this desired effect will be described in greater detail below. The efficient sampling module 102 can also be configured to, for each sample set, determine an evaluation subset of the sample set such that data elements included in the evaluation subset are analyzed, and data elements not included in the evaluation subset are not analyzed. In other words, the efficient sampling module 102 can be configured to determine, for each data element in a sample set, whether the data element needs to be analyzed (i.e., whether the data element should be added to the evaluation subset), or whether the data element does not need to be analyzed, for example, based on a previous analysis of the data element.

For example, consider the scenario of a medical study, in which participants are tested to determine whether or not they have ever contracted a particular disease (e.g., chickenpox). Of course, it may not be possible to test the entire human population. As such, a representative sample set of ten thousand people can be selected for testing. A first sample set of ten thousand people can be selected at a first time for a first analysis, and the sample set can be tested to see how many of these people have ever contracted chickenpox. The study may want to test at a later time another sample set of people to see whether the percentage of the population that has contracted chickenpox is increasing, decreasing, or staying the same. As such, at a later, second time, a second sample set of ten thousand people can be selected for a second analysis. If the second sample set is selected completely at random, given the number of people in the population, it is highly unlikely that the second sample set of ten thousand people will have any substantial overlap with the first sample set of ten thousand people. As such, all or nearly all ten thousand people in the second sample set would have to be tested. However, if the second sample set is selected in such a way as to increase the likelihood of overlap with the first sample set, then the second analysis may be undertaken more efficiently. For example, any members of the second sample set that were in the first sample set, and previously tested positive for chickenpox, would not have to be analyzed again. They can simply be marked as having previously contracted chicken pox. As such, these people would not be included in the evaluation subset for the second analysis. The evaluation subset would include only those people in the second sample set that were not in the first sample set (i.e., are new additions and have never been analyzed), or were in the first sample set, but at that time had never contracted chicken pox (in case they did contract chicken pox in the time period between the first analysis and the second analysis).

As shown in the example of FIG. 1, the efficient sampling module 102 can include a sample set selection module 104 and an evaluation subset determination module 106. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the efficient sampling module 102 can be implemented in any suitable combinations.

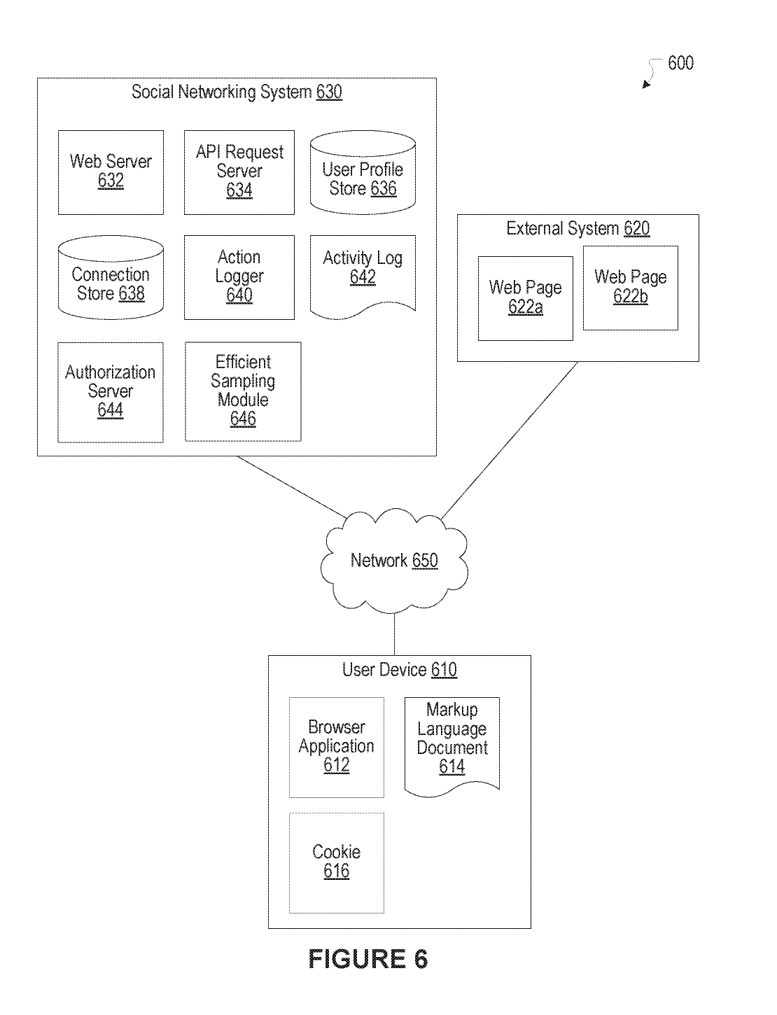

In some embodiments, the efficient sampling module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the efficient sampling module 102 can be implemented, in part or in whole, as software running on one or more computing devices or systems, such as on a user or client computing device. For example, the efficient sampling module 102, or at least a portion thereof, can be implemented as or within an application (e.g., app), a program, or an applet, etc., running on a user computing device or a client computing system, such as the user device 610 of FIG. 6. In another example, the efficient sampling module 102, or at least a portion thereof, can be implemented using one or more computing devices or systems that include one or more servers, such as network servers or cloud servers. In some instances, the efficient sampling module 102 can, in part or in whole, be implemented within or configured to operate in conjunction with a social networking system (or service), such as the social networking system 630 of FIG. 6. It should be understood that there can be many variations or other possibilities.

The efficient sampling module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the efficient sampling module 102. For example, the data store 110 can store dataset information, data elements, sample sets, one or more random number generators, one or more data comparison functions, and the like. It is contemplated that there can be many variations or other possibilities.

The sample set selection module 104 can be configured to select a sample set from a dataset. As discussed above, a dataset can comprise one or more data elements. A sample set can comprise a subset of the one or more data elements contained in the dataset. In certain embodiments, the sample set selection module 104 can be configured to determine a priority score for each data element in a dataset. In certain embodiments, the priority score can be determined based on a weight assigned to each data element and a random number associated with each data element. The data elements in a dataset can be ranked based on priority score, and a sample set can be selected based on the ranking. For example, the top k data elements based on priority score can be selected for the sample set. The sample set selection module 104 will be described in greater detail herein.

The evaluation subset determination module 106 can be configured to determine an evaluation subset of one or more data elements from a sample set for analysis. As discussed above, when a sample set is selected, certain data elements may not need to be analyzed. For example, a data element that has previously been analyzed in a previously analysis may not need to be analyzed again. In certain scenarios, the evaluation subset will include all data elements from the sample set. For example, in the very first sample set selected for the very first analysis, there would be no previous sample set against which to compare the current sample set, and all data elements in the current sample set would have to be analyzed. However, for subsequent sample sets, the evaluation subset determination module 106 can be configured to determine which data elements in the sample set do and which do not have to be analyzed, so as to improve the efficiency of the subsequent analysis. The evaluation subset determination module 106 will be described in greater detail herein.

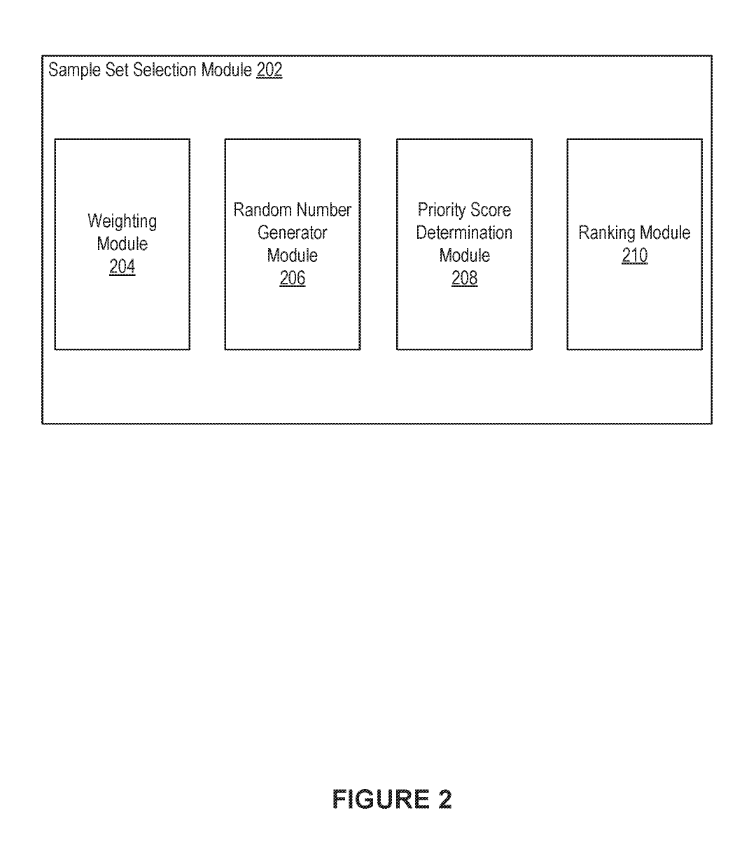

FIG. 2 illustrates an example sample set selection module 202 configured to select a sample set of data elements from a dataset, according to an embodiment of the present disclosure. In some embodiments, the sample set selection module 104 of FIG. 1 can be implemented as the sample set selection module 202. As shown in the example of FIG. 2, the sample set selection module 202 can include a weighting module 204, a random number generator module 206, a priority score determination module 208, and a ranking module 210.

The weighting module 204 can be configured to assign weights to each data element in a dataset. The weight associated with each data element can be used in determining a priority score for each data element, as described in greater detail in the present disclosure. Weights can either be manually determined, automatically determined, or a combination of the two. Weighting can be determined based on various weighting criteria. In certain embodiments, weighting criteria can be determined so as to generate a sample set that is representative of the dataset. For example, returning to the example of a medical study of a population, each data element can represent an individual person based on various characteristics, e.g., gender, ethnicity, age group. The weight for each data element can be assigned so that the sample set will be statistically representative of the population as a whole based on one or more characteristics. For example, if the medical study wants a sample set that is representative of the gender ratio of university students, and 60% of university students are female and 40% of university students are male, and the population that is being sampled has a gender ratio of 50% female and 50% male, each data element corresponding to a female, in the population at large, can be assigned a weight of 0.6, and each data element corresponding to a male can be assigned a weight of 0.4 to model the gender bias of university students.

In certain embodiments, weights can be determined based on an importance of each data element. Consider the example scenario of a social networking system that houses a database of places of interest. This database can include information about various places of interest, such as restaurants, landmarks, hotels, businesses, etc. Each place of interest can have an associated account or page on the social networking system, and each data element in the places of interest database can be associated with a particular place of interest page. The places of interest database can be analyzed, for example, to confirm the accuracy of information contained in place of interest pages, e.g., to confirm the name, address, phone number, business hours, etc. for each place of interest page. The weight assigned to each data element can be based on a popularity or importance of each place of interest page on the social networking system. For example, the popularity or importance of a place of interest page can be determined based on social networking system interaction information for each place of interest page on the social networking system (e.g., number of likes, followers, comments, check-ins, reviews, a combination of the foregoing characteristics, and the like).

The random number generator module 206 can be configured to generate a random number for each data element in a dataset. As will be described in greater detail below, the random number associated with a data element can be utilized in conjunction with the weight of the data element to determine a priority score for the data element. In certain embodiments, the random number generated for a particular data element can be deterministically calculated so that a particular data element will always result in the same random number being generated. For example, each data element in a dataset can be associated with a unique ID. The random number generator module 206 can be configured to calculate a random number based on the unique ID such that, so long as the data element has the same unique ID, the same random number will be generated for that data element. In certain embodiments, the random number can be a number between 0 and 1.

The priority score determination module 208 can be configured to determine a priority score for each data element in a dataset. In certain embodiments, the priority score can be determined based on a weight and a random number associated with each data element. For example, the priority score for a data element can be based on a product or a quotient of the weight and the random number for the data element.

The ranking module 210 can be configured to rank the data elements in a dataset based on ranking criteria. In certain embodiments, data elements in a dataset can be ranked based on priority score. A sample set of the dataset can be selected based on the ranking. For example, the top k data elements in a dataset can be selected based on priority score. If a sample set of 10,000 data elements is desired, for example, then the data elements having the top 10,000 priority scores can be selected for inclusion in the sample set.

By selecting sample sets in the manner described above, the likelihood of overlap in subsequent sample sets can be increased. This is particularly true if the weights associated with each data element do not change significantly over time. As discussed previously, over time, a dataset may change such that new data elements can be added, previous data elements may be removed, or previous data elements may be updated. Weightings of data elements may change or be updated based on changes to the dataset. For example, in the examples discussed above, if the population demographics change, this can result in a change in weightings, or if social network interaction data changes over time, weights for each place of interest can be updated. However, as long as the weights remain generally consistent, it is highly likely that those data elements that were ranked highly in a first sample set selection will continue to rank highly in subsequent sample set selections, resulting in overlapping data elements from one sample set selection to another. These overlapping data elements can increase the likelihood of data elements that do not have to be analyzed in current or subsequent analyses based on the fact that those data elements have previously been analyzed.

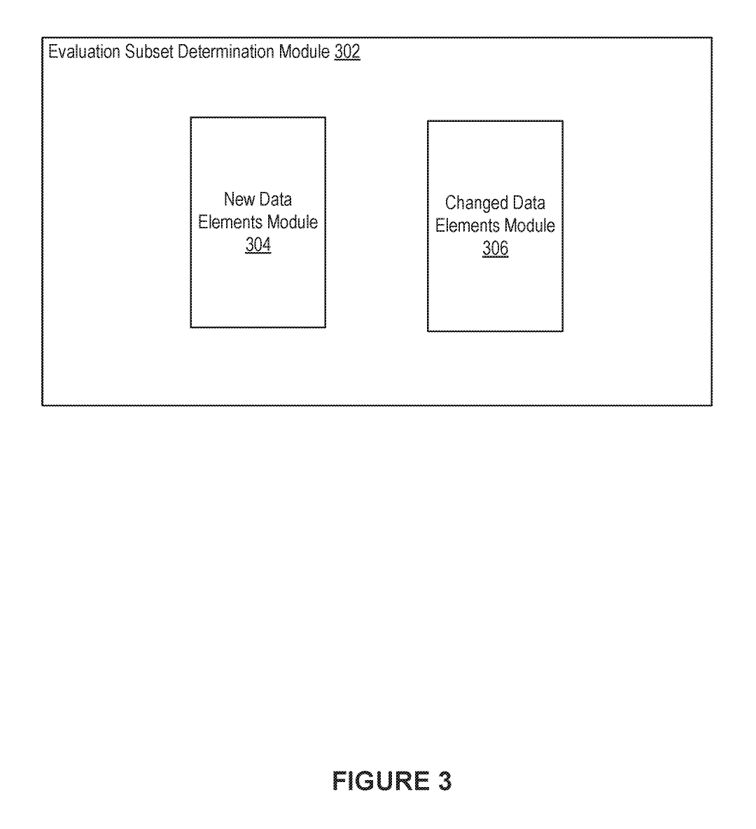

FIG. 3 illustrates an example evaluation subset determination module 302 configured to select an evaluation subset comprising one or more data elements from a sample set, according to an embodiment of the present disclosure. In some embodiments, the evaluation subset determination module 106 of FIG. 1 can be implemented as the evaluation subset determination module 302. As shown in the example of FIG. 3, the evaluation subset determination module 302 can include a new data elements module 304 and a changed data elements module 304.

The new data elements module 304 can be configured to determine which data elements in a sample set are new data elements, i.e., have not been previously analyzed as part of a previous sample set. As discussed above, data elements that were part of previous sample sets that were previously analyzed may not need to be analyzed again. However, any data elements that are “new,” i.e., have not previously been analyzed, will need to be included in the evaluation subset for analysis. As such, the evaluation subset determination module 302 can be configured to determine any data elements in a sample set that have not been previously analyzed and to include these data elements in the evaluation subset. In certain embodiments, a “new data element” may be determined based on having never been in any previous sample sets or having never been previously analyzed. However, in certain embodiments, a “new data element” may be determined based on having not been included in a sample set for a particular number of previous sample sets, or for a predetermined amount of time. For example, a data element can be identified as a “new data element” if it was not in the immediately preceding sample set, or if it has not been included in any of the previous 10 sample sets, or if it has not been included in a sample set for one year or more. As such, even if a data element was previously included in a sample set, it may still be identified as a “new data element” to be included in the evaluation subset.

The changed data elements module 306 can be configured to determine which data elements in a sample set are not new data elements, but should still be included in the evaluation subset because they require additional analysis. As discussed above, data elements that were part of a previous analysis may not need to be analyzed in a current or subsequent analyses. However, if the data element has been changed since the last analysis, or may have changed since the last analysis, the change in information or potential change in information may affect that analysis. In these scenarios, these data elements that have changed or could potentially have changed may need to be included in the evaluation subset. For example, in the example scenario of the chickenpox study, any study participants that had already contracted chickenpox as of the last analysis need not be analyzed again, but any participants that had not contracted chickenpox may need to be analyzed again, as they may have contracted chickenpox in the time between the first and second analyses. The changed data elements module 306 can be configured to identify any data elements that were in one or more previous sample sets, but still require further analysis. For example, further analysis may be required based on an actual change that has already occurred, i.e., the data element has changed since the last analysis, or based on a potential change that may have occurred and can only be discovered with additional analysis.

In certain embodiments, any change to a data element may result in the data element's inclusion in the evaluation subset. In other embodiments, data elements may be included in the evaluation subset based on a determination of a nature or extent of a change. For example, data elements could be included in the evaluation subset if they satisfy a threshold level of change, or satisfy a change threshold determination. In certain embodiments, the changed data elements module 306 can implement a comparison function to compare a data element at a first time and the same data element at a second time to determine the extent and/or nature of any change in the data element. For example, in the example of the places of interest database discussed above, a change in capitalization or punctuation in a place of interest's name may not be sufficient to include the data element in the evaluation subset, but a more significant change in the name, or a change in address or phone number, may result in the data element being placed in the evaluation subset.

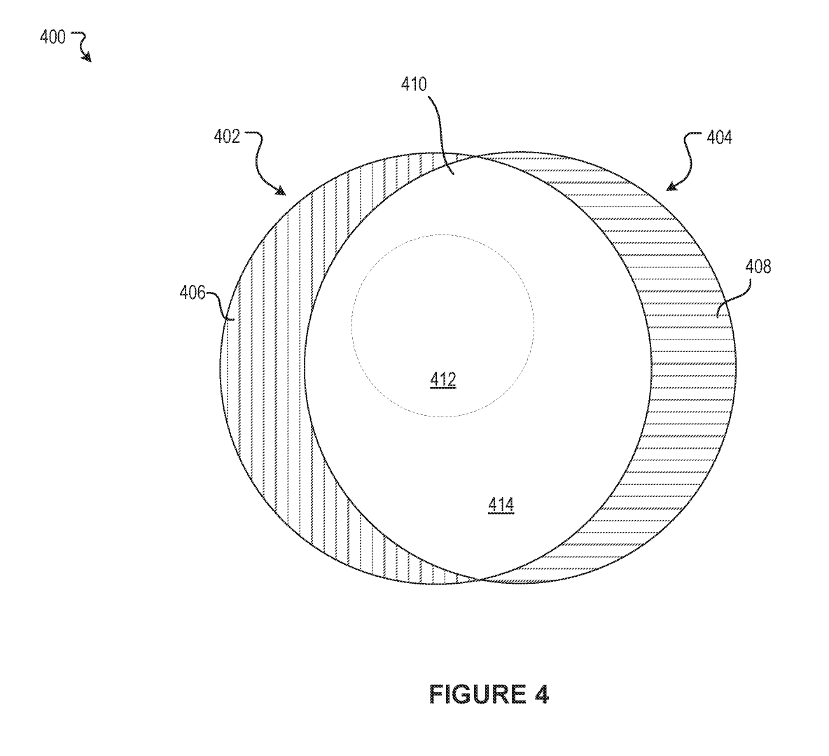

FIG. 4 illustrates an example scenario 400 associated with selecting an evaluation subset from a sample set, according to an embodiment of the present disclosure. The example scenario 400 includes a first sample set 402 that includes one or more data elements selected from a dataset at a first time for a first analysis. The example scenario 400 also includes a second sample set 404 that includes one or more data elements selected from the dataset at a second time for a second analysis. It can be seen that a portion of the two sample sets 402, 404 overlap in a central, overlapping portion 410. A portion 406 of the first sample set 402 does not overlap with the second sample set 404, and a portion 408 of the second sample set 404 does not overlap with the first sample set 402. The portion 406 can represent, for example, data elements that were in the first sample set 402, but are not in the second sample set 404. The portion 408 can represent new data elements in the second sample set 404 that were not in the first sample set 402.

The overlapping portion 410 can represent data elements that are in both the first sample set 402 and the second sample set 404. A first subset 412 of the overlapping data elements 410 is representative of data elements that have been identified as requiring further analysis, despite having been previously analyzed. This may be because, for example, these data elements have changed since the last analysis, or may have changed since the last analysis and, therefore, require further analysis. A second subset 414 of the overlapping data elements 410 is representative of data elements the have been identified as having been previously analyzed, and that do not need to be analyzed in the second analysis. The data elements in the portion 406 are not in the new sample set 404, and, therefore, are not eligible for the second analysis. The data elements in the portions 408 (new data elements) and 412 (previously analyzed data elements that need to be analyzed again) represent data elements to be included in the evaluation subset. The data elements in the portion 414 have been previously analyzed and do not need to be analyzed again in the second analysis. As such, the data elements in the portion 414 represent a savings in time and/or cost for the second analysis.

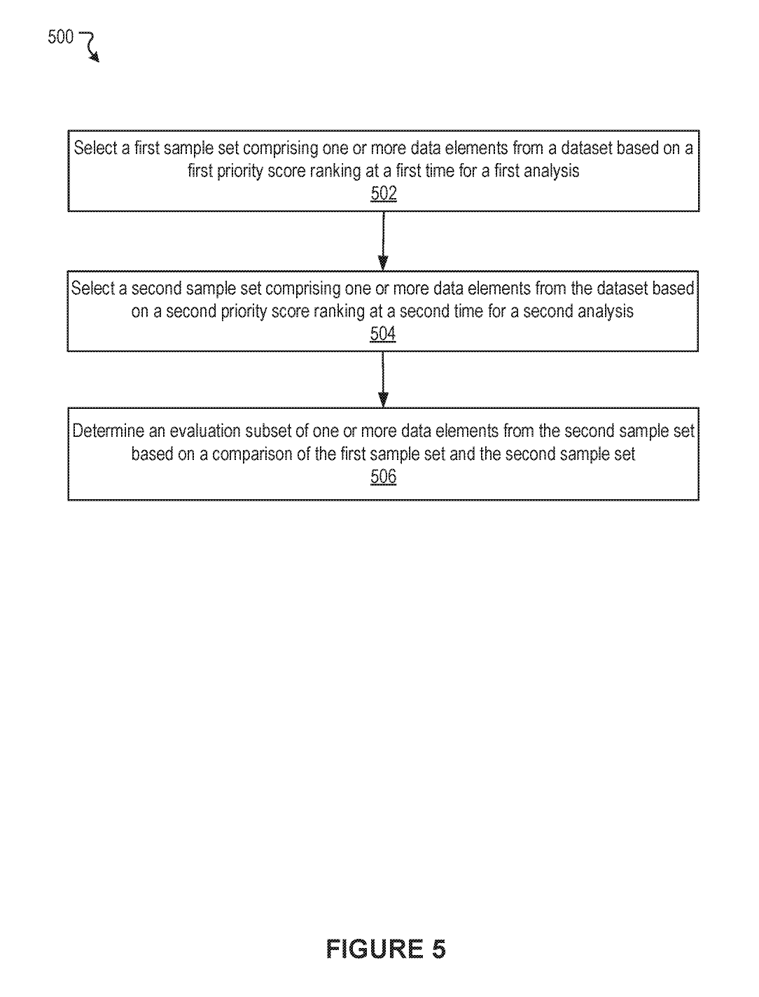

FIG. 5 illustrates an example method 500 associated with efficient sampling, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can select a first sample set comprising one or more data elements from a dataset based on a first priority score ranking at a first time for a first analysis. At block 504, the example method 500 can select a second sample set comprising one or more data elements from the dataset based on a second priority score ranking at a second time for a second analysis. At block 506, the example method 500 can determine an evaluation subset of one or more data elements from the second sample set based on a comparison of the first sample set and the second sample set.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an efficient sampling module 646. The efficient sampling module 646 can, for example, be implemented as the efficient sampling module 102, as discussed in more detail herein. As discussed previously, it should be appreciated that there can be many variations or other possibilities. For example, in some embodiments, one or more functionalities of the efficient sampling module 646 can be implemented in the user device 610.

### Hardware Implementation

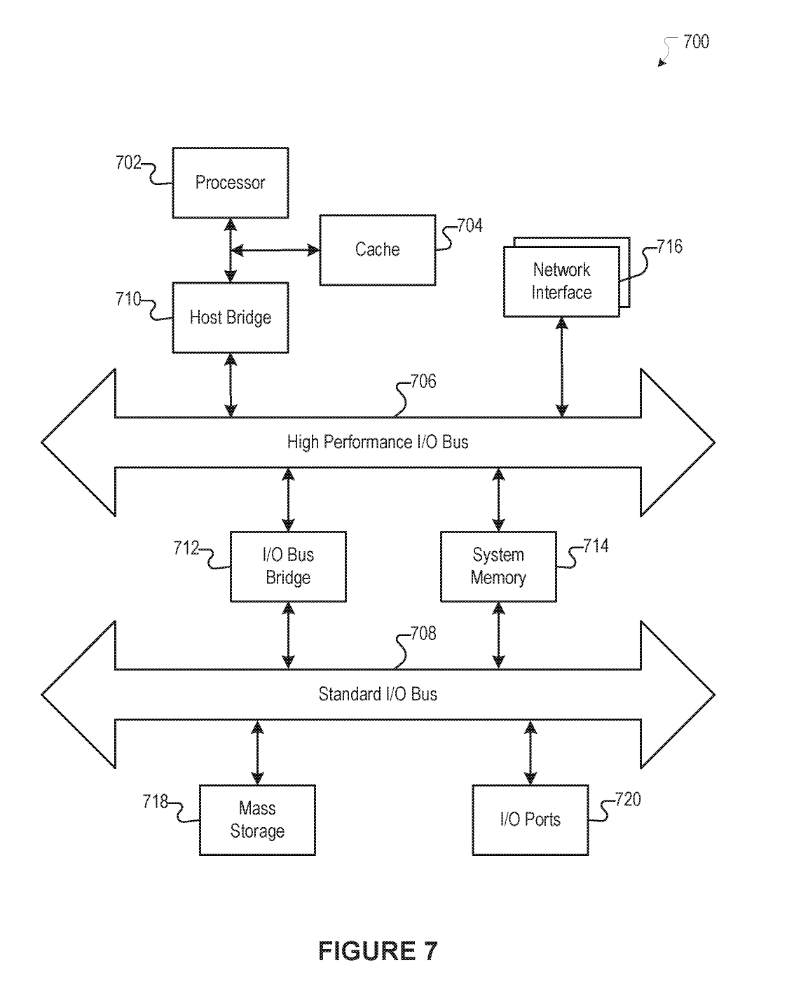

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
selecting, by a computing system, a first sample set comprising one or more data elements from a dataset based on a first priority score ranking at a first time for a first analysis;
selecting, by the computing system, a second sample set comprising one or more data elements from the dataset based on a second priority score ranking at a second time for a second analysis; and
determining, by the computing system, an evaluation subset of one or more data elements from the second sample set based on a comparison of the first sample set and the second sample set,
wherein data elements in the second sample set that are not included in the evaluation subset are not analyzed in the second analysis.

2. The computer-implemented method of claim 1, wherein each data element of the dataset is associated with a weight.

3. The computer-implemented method of claim 2, wherein each data element of the dataset is associated with a random number.

4. The computer-implemented method of claim 3, wherein each random number is determined based on a unique ID associated with each data element.

5. The computer-implemented method of claim 3, wherein each data element of the dataset is associated with a priority score determined based on the weight and the random number.

6. The computer-implemented method of claim 5, wherein
the first sample set comprises the top k data elements in the dataset based on the first priority score ranking at the first time, k being a predetermined number, and
the second sample set comprises the top k data elements in the dataset based on the second priority score ranking at the second time.

7. The computer-implemented method of claim 6, wherein
the dataset comprises a places of interest database, and
each data element in the places of interest database is associated with a place of interest page on a social networking system

8. The computer-implemented method of claim 7, wherein the weight associated with each place of interest page in the places of interest database is determined based on social networking system interaction information for each place of interest page.

9. The computer-implemented method of claim 8, wherein the first analysis and the second analysis comprises analyzing accuracy of information contained in place of interest pages.

10. The computer-implemented method of claim 1, wherein the determining an evaluation subset comprises including in the evaluation subset data elements in at least one of the following categories:
data elements in the second sample set that were not in the first sample set,
data elements in the second sample set that were in the first sample set and have been modified,
data elements in the second sample set that were in the first sample set, have been modified, and satisfy a change threshold determination, or
data elements in the second sample set that were in the first sample set, and for which a result of the first analysis indicated the need for additional analysis.

11. A system comprising:
at least one processor; and
a memory storing instructions that, when executed by the at least one processor, cause the system to perform a method comprising:
selecting a first sample set comprising one or more data elements from a dataset based on a first priority score ranking at a first time for a first analysis;
selecting a second sample set comprising one or more data elements from the dataset based on a second priority score ranking at a second time for a second analysis; and
determining an evaluation subset of one or more data elements from the second sample set based on a comparison of the first sample set and the second sample set,
wherein data elements in the second sample set that are not included in the evaluation subset are not analyzed in the second analysis.

12. The system of claim 11, wherein each data element of the dataset is associated with a weight.

13. The system of claim 12, wherein each data element of the dataset is associated with a random number.

14. The system of claim 13, wherein each random number is determined based on a unique ID associated with each data element.

15. The system of claim 13, wherein each data element of the dataset is associated with a priority score determined based on the weight and the random number.

16. A non-transitory computer-readable storage medium including instructions that, when executed by at least one processor of a computing system, cause the computing system to perform a method comprising:
selecting a first sample set comprising one or more data elements from a dataset based on a first priority score ranking at a first time for a first analysis;
selecting a second sample set comprising one or more data elements from the dataset based on a second priority score ranking at a second time for a second analysis; and
determining an evaluation subset of one or more data elements from the second sample set based on a comparison of the first sample set and the second sample set,
wherein data elements in the second sample set that are not included in the evaluation subset are not analyzed in the second analysis.

17. The non-transitory computer-readable storage medium of claim 16, wherein each data element of the dataset is associated with a weight.

18. The non-transitory computer-readable storage medium of claim 17, wherein each data element of the dataset is associated with a random number.

19. The non-transitory computer-readable storage medium of claim 18, wherein each random number is determined based on a unique ID associated with each data element.

20. The non-transitory computer-readable storage medium of claim 18, wherein each data element of the dataset is associated with a priority score determined based on the weight and the random number.
